(19) United States
(12) Patent Application Publication
(10) Pub. No.: US 2025/0363339 A1
(43) Pub. Date: Nov. 27, 2025

(54) HEAD ARCHITECTURE FOR DEEP NEURAL NETWORK (DNN)

(71) Applicant: Intel Corporation, Santa Clara, CA (US)

(72) Inventors: Anbang Yao, Beijing (CN); Chao Li, Beijing (CN); Dongqi Cai, Beijing (CN); Xiaolong Liu, Beijing (CN); Wenjian Shao, Shanghai (CN)

(73) Assignee: Intel Corporation, Santa Clara, CA (US)

(21) Appl. No.: 18/997,876

(22) PCT Filed: Aug. 26, 2022
(86) PCT No.: PCT/CN2022/115254

§ 371 Date: Jan. 23, 2025

(51) Int. Cl. G06N 3/048; G06N 3/0464

(52) U.S. Cl. CPC G06N 3/048; G06N 3/0464

(57) ABSTRACT

A head of a DNN receives an OFM from a backbone network of the DNN. The head can partition the OFM into feature groups having same sizes. The head can further generate local tensors from the features group. To generate a local tensor from a feature group, the head may further partition the feature group into two subgroups, e.g., based on a splitting factor. The spatial sizes of the subgroups depend on the splitting factor. One subgroup can be converted into an attention tensor. The other subject can be converted into a value tensor, which may have the same size as the attention tensor. The attention tensor and value tensor are mixed to produce the local tensor. The local tensors of all the feature groups can be aggregated to form a global vector, which can be fed into a classifier to output one or more classification determined by the DNN.

### TECHNICAL FIELD

This disclosure relates generally to neural networks, and more specifically, to a head architecture for DNNs.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of operations. Therefore, techniques to improve performance of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN including a backbone network and a head module, in accordance with various embodiments.

FIG. 2 illustrates a layered architecture of an example DNN, in accordance with various embodiments.

FIG. 3 is a block diagram of a head module, in accordance with various embodiments.

FIG. 4 illustrates a feature splitting process, in accordance with various embodiments.

FIG. 5 illustrates a feature integration process, in accordance with various embodiments.

FIG. 6 illustrates a feature aggregation process, in accordance with various embodiments.

FIG. 7 is a flowchart showing a method of deep learning, in accordance with various embodiments.

FIG. 8 illustrates a DL (deep learning) environment, in accordance with various embodiments.

FIG. 9 is a block diagram of an example DNN system, in accordance with various embodiments.

FIG. 10 is a block diagram of an example computing device, in accordance with various embodiments.

### DETAILED DESCRIPTION

### Overview

DNNs are widely used in the domains of computer vision, speech recognition, image, and video processing mainly due to their ability to achieve beyond human-level accuracy. DNN architectures are typically designed with a de-facto engineering pipeline that decomposes the network body into two parts: a backbone for feature extraction and a head for feature encoding and output predication. There are lots of substantial research efforts in the backbone engineering. Currently available DNN architectures in general have evolved into three major categories: convolutional neural networks (CNNs) with convolutional layers, vision transformers (ViTs) with self-attention layers, and multi-layer perceptrons (MLPs) with linear layers. The head structures of prevailing DNNs in general share a similar processing pipeline.

For instance, top-performing CNNs, such as ResNet, MobileNet, ShuffleNet and ConvNeXt, follow the head design of GoogLeNet, which consists of a global average pooling (GAP) layer, a fully connected layer and a softmax classifier. The ViT architecture adopts a patchify stem where the self-attention is directly computed within non-overlapping local image patches (i.e., visual tokens). The head of ViTs usually comprises a fully connected layer and a softmax classifier and takes the representation of an extra class token (e.g., a learnable embedding vector) as the input to predict the classification output. MLPs retain the patchify stem of ViTs, but remove the self-attention component. Regarding the choice of head structure, they all adopt the GAP-based design, similar to modern CNNs like GoogLeNet, ResNet, MobileNet, ShuffleNet and ResNeXt.

In sum, the head structures of prevailing CNNs, ViTs and MLPs share a similar processing pipeline. Such processing pipelines exploit global feature dependencies but disregard local ones. This can significantly limit the performance of learnt models. For instance, these processing pipelines are usually incapable of capturing rich class-specific cues as they coarsely process critical information about the spatial layout of local features, limiting the final feature abstraction ability of image recognition models and leading to suboptimal performance. This drawback can be more significant for compact DNNs developed to adapt resource-constrained environments. Therefore, improved technology for heads of DNNs is needed.

Embodiments of the present disclosure may improve on at least some of the challenges and issues described above by providing a head architecture that can model group-wise local-to-global feature dependencies, e.g., through group-wise feature partition, integration and aggregation.

In various embodiments of the present disclosure, an OFM (output feature map) from a backbone network is partitioned into a plurality of feature groups by a head. The OFM may be a result of the backbone network processing an input fed into a DNN that includes the backbone network and the head. An OFM may also be referred to as an output tensor. An OFM includes a plurality of channels. A channel of the plurality of channels is a matrix comprising a plurality of values. Each value may be referred to as a pixel or element. The number of values in a column of the matrix may be referred to as a channel height of the OFM. The number of values in a row of the matrix may be referred to as a channel width of the OFM. The OFM has a spatial size defined by the channel height, channel width, and number of channels. The feature groups are different portions of the OFM. The partition may be done along the channel axis. In some embodiments, the feature groups include different portions of the plurality of channels in the OFM. The feature groups can have a same number of channels. The channel height or channel width of a feature group may be the same as the channel height or channel width of the OFM.

The head can process the feature groups separately or in parallel. A local tensor is generated from a feature group. The feature group may be partitioned into two feature subgroups, which may have different numbers of channels. An attention tensor can be generated from one of the feature subgroups, e.g., through convolution and activation function. A value tensor can be generated from the other feature subgroup, e.g., through convolution. The attention tensor and value tensor have the same spatial size and can be mixed, e.g., through elementwise multiplication, into a local tensor.

The local tensors of all the feature groups can be aggregated into a global vector, e.g., through a series of aggregation operations. The global vector can be used to produce a determination (e.g., classification, prediction, estimation, etc.) of the DNN. In an example where the determination is classification, a classifier (e.g., a softmax classifier) can process the global vector and output one or more values, each of which indicating a likelihood of the input falls under a category.

Compared with conventional methods for head computation, the present disclosure provides a universal head architecture that is applicable to various types of backbone networks, including CNN, ViT, and MLP. Also, the head architecture has better efficiency and accuracy. For instance, the computation in the head architecture is less complicated compared with the many conventional head architectures. Such head architecture would require less power, computation resource, and time.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

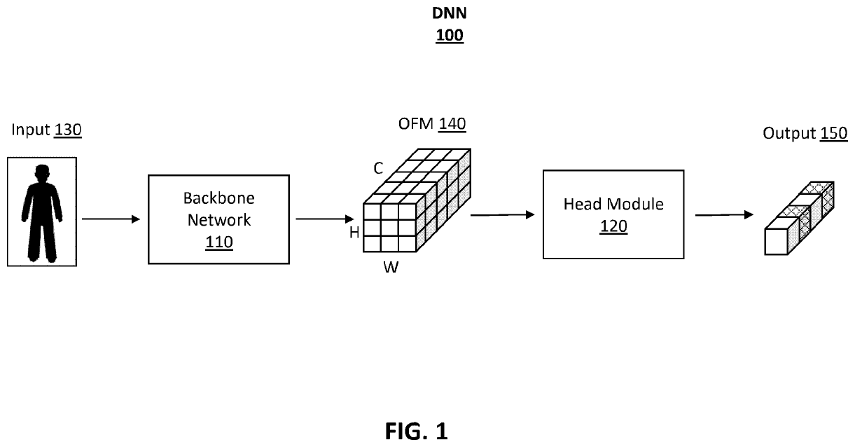

FIG. 1 illustrates an example DNN 100 including a backbone network 110 and a head module 120, in accordance with various embodiments. In other embodiments, alternative configurations, different or additional components may be included in the DNN 100. Further, functionality attributed to a component of the DNN 100 may be accomplished by a different component included in the DNN 100 or a different system.

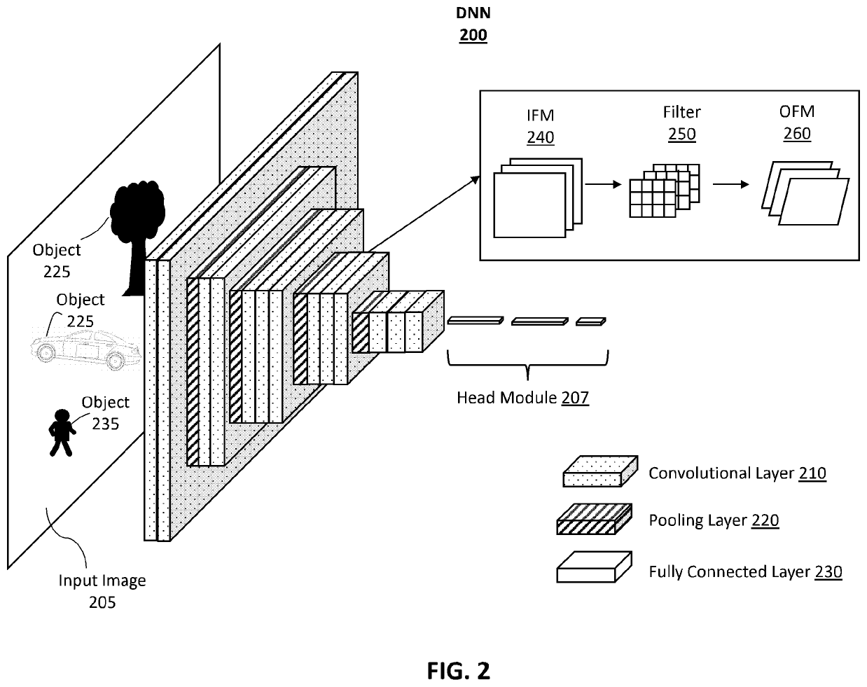

The backbone network 110 receives an input 130 and extract features form the input 130. In some embodiments, the input 130 may be an image of one or more objects. An object may be a person, a building, a vehicle, a structure, and so on. The backbone network 110 may be a network of a plurality of layers, such as convolutional layers, self-attention layers, linear layers, pooling layers, other types of neural network layers, or some combination thereof. Through extracting features from the input 130, the backbone network 110 generates an OFM 140. An example of the OFM 140 is the OFM 260 in FIG. 2. In some embodiments, the OFM 140 includes a plurality of channels. Each channel may be a matrix including numbers arranged in columns and rows. The OFM 140 may be represented as a cuboid, the spatial size of which is defined by the dimensions: channel height H, channel width W, and the number of channels C. The spatial size can be denoted as H×W×C. For purpose of illustration and simplicity, the OFM 140 has a spatial size of 3×3×5. Every value in the OFM 140 may be referred to as an element or pixel, which is represented as a cube in FIG. 1. In the embodiment of FIG. 1, the OFM 140 includes 9 pixels in each of the 5 channels.

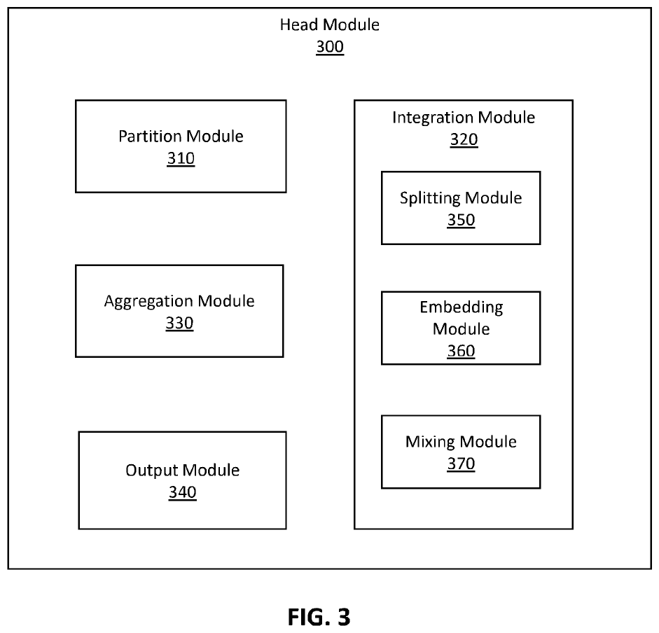

The head module 120 receives the OFM 140 from the backbone network 110. The head module 120 can process the OFM 140 to determine an output 150 of the DNN 100 based on the OFM 130. The head module 120 may apply one or more operations on the OFM 140 to generate the output 150. The operations may include encoding operation, convolutional operation, linear operation, activation function, multiplication, accumulation, other types of operation, or some combination thereof. Examples of the head module 120 include the head module 207 in FIG. 2 and the head module 300 in FIG. 3. In some embodiments, the output 150 is tailored to one or more AI tasks, e.g., a task based on which the DNN 100 is trained and a task to be performed by the DNN 100 after being trained. The output 150 may represent one or more determinations made by the DNN 100 based on the input 130. A determination of the DNN 100 may be a solution for a problem for which the DNN 100 is trained. A determination may be a classification, prediction, estimation, and so on. The output 150 may include multiple values. For purpose of illustration and simplicity, the output 150 in FIG. 1 includes 4 values, represented by 4 cubes. In an example, each value may indicate a probability that an object in the input 130 falls under a category.

FIG. 2 illustrates a layered architecture of an example DNN 200, in accordance with various embodiments. For purpose of illustration, the DNN 200 in FIG. 2 is a CNN. In other embodiments, the DNN 200 may be other types of DNNs. The DNN 200 is trained to receive images and output classifications of objects in the images. In the embodiment of FIG. 2, the DNN 200 receives an input image 205 that includes objects 215, 225, and 235. The DNN 200 includes a sequence of layers comprising a plurality of convolutional layers 210 (individually referred to as “convolutional layer 210”), a plurality of pooling layers 220 (individually referred to as “pooling layer 220”), and a plurality of fully connected layers 230 (individually referred to as “fully connected layer 230”). In other embodiments, the DNN 200 may include fewer, more, or different layers.

The convolutional layers 210 summarize the presence of features in the input image 205. In the embodiment of FIG. 2, the first layer of the DNN 200 is a convolutional layer 210. The convolutional layers 210 function as feature extractors. A convolutional layer 210 can receive an input and outputs features extracted from the input. In an example, a convolutional layer 210 performs a convolution to an IFM (input feature map) 240 by using a filter 250, generates an OFM 260 from the convolution, and passes the OFM 260 to the next layer in the sequence. The IFM 240 may include a plurality of IFM matrices. The filter 250 may include a plurality of weight matrices. The OFM 260 may include a plurality of OFM matrices. For the first convolutional layer 210, which is also the first layer of the DNN 200, the IFM 240 is the input image 205. For the other convolutional layers, the IFM 240 may be an output of another convolutional layer 210 or an output of a pooling layer 220.

A convolution may be a linear operation that involves the multiplication of a weight operand in the filter 250 with a weight operand-sized patch of the IFM 240. A weight operand may be a weight matrix in the filter 250, such as a 2-dimensional array of weights, where the weights are arranged in columns and rows. Weights can be initialized and updated by backpropagation using gradient descent. The magnitudes of the weights can indicate importance of the filter 250 in extracting features from the IFM 240. A weight operand can be smaller than the IFM 240. The multiplication can be an elementwise multiplication between the weight operand-sized patch of the IFM 240 and the corresponding weight operand, which is then summed, always resulting in a single value. Because it results in a single value, the operation is often referred to as the “scalar product.”

In some embodiments, using a weight operand smaller than the IFM 240 is intentional as it allows the same weight operand (set of weights) to be multiplied by the IFM 240 multiple times at different points on the IFM 240. Specifically, the weight operand is applied systematically to each overlapping part or weight operand-sized patch of the IFM 240, left to right, top to bottom. The result from multiplying the weight operand with the IFM 240 one time is a single value. As the weight operand is applied multiple times to the IFM 240, the multiplication result is a two-dimensional array of output values that represent a weight operanding of the IFM 240. As such, the 2-dimensional output array from this operation is referred to a “feature map.”

In some embodiments, the OFM 260 is passed through an activation function. An example activation function is the rectified linear activation function (ReLU). ReLU is a calculation that returns the value provided as input directly, or the value zero if the input is zero or less. The convolutional layer 210 may receive several images as input and calculates the convolution of each of them with each of the weight operands. This process can be repeated several times. For instance, the OFM 260 is passed to the subsequent convolutional layer 210 (i.e., the convolutional layer 210 following the convolutional layer 210 generating the OFM 260 in the sequence). The subsequent convolutional layers 210 performs a convolution on the OFM 260 with new weight operands and generates a new feature map. The new feature map may also be normalized and resized. The new feature map can be weight operanded again by a further subsequent convolutional layer 210, and so on.

In some embodiments, a convolutional layer 210 has four hyperparameters: the number of weight operands, the size F weight operands (e.g., a weight operand is of dimensions F×F×D pixels), the S step with which the window corresponding to the weight operand is dragged on the image (e.g., a step of one means moving the window one pixel at a time), and the zero-padding P (e.g., adding a black contour of P pixels thickness to the input image of the convolutional layer 210). The convolutional layers 210 may perform various types of convolutions, such as 2-dimensional convolution, dilated or atrous convolution, spatial separable convolution, depth-wise separable convolution, transposed convolution, and so on. The DNN 200 includes 26 convolutional layers 210. In other embodiments, the DNN 200 may include a different number of convolutional layers.

The pooling layers 220 down-sample feature maps generated by the convolutional layers, e.g., by summarizing the presents of features in the patches of the feature maps. A pooling layer 220 is placed between two convolutional layers 210: a preceding convolutional layer 210 (the convolutional layer 210 preceding the pooling layer 220 in the sequence of layers) and a subsequent convolutional layer 210 (the convolutional layer 210 subsequent to the pooling layer 220 in the sequence of layers). In some embodiments, a pooling layer 220 is added after a convolutional layer 210, e.g., after an activation function (e.g., ReLU) has been applied to the OFM 260.

A pooling layer 220 receives feature maps generated by the preceding convolutional layer 210 and applies a pooling operation to the feature maps. The pooling operation reduces the size of the feature maps while preserving their important characteristics. Accordingly, the pooling operation improves the efficiency of the DNN and avoids over-learning. The pooling layers 220 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 220 applied to a feature map of 6×6 results in an output pooled feature map of 3×3. The output of the pooling layer 220 is inputted into the subsequent convolutional layer 210 for further feature extraction. In some embodiments, the pooling layer 220 operates upon each feature map separately to create a new set of the same number of pooled feature maps.

The fully connected layers 230 are the last layers of the DNN 200 and constitute a head module 207 of the DNN 200, where the convolutional layers 210 and pooling layers 220 constitute a backbone network of the DNN 200. The fully connected layers 230 may be convolutional or not. The fully connected layers 230 receives an input operand, an example of which is the OFM 130. The input operand defines the output of the convolutional layers 210 and pooling layers 220 and includes the values of the last feature map generated by the last layer before the first fully connected layer 230. In the embodiment of FIG. 2, the last layer before the first fully connected layer 230 is a convolutional layer 210. In other embodiments, last layer before the first fully connected layer 230 may be a pooling layer 220.

The fully connected layers 230 may apply a linear combination and an activation function to the input operand and generates an individual partial sum. The individual partial sum may contain as many elements as there are classes: element i represents the probability that the image belongs to class i. Each element is therefore between 0 and 2, and the sum of all is worth one. These probabilities may be calculated by the last fully connected layer 230 by using a logistic function (binary classification) or a softmax function (multi-class classification) as an activation function.

In some embodiments, the fully connected layers 230 classify the input image 205 and returns an operand of size N, where N is the number of classes in the image classification problem. In the embodiment of FIG. 2, N equals 3, as there are three objects 215, 225, and 235 in the input image. Each element of the operand indicates the probability for the input image 205 to belong to a class. To calculate the probabilities, the fully connected layers 230 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 215 being a tree, a second probability indicating the object 225 being a car, and a third probability indicating the object 235 being a person. In other embodiments where the input image 205 includes different objects or a different number of objects, the individual partial sum can be different.

### Example Head Module

FIG. 3 is a block diagram of a head module 300, in accordance with various embodiments. The head module 300 receives a feature map from a backbone network and processes the feature map to generate a determination by a DNN in which the head module 300 is arranged. The head module 300 may be implemented in hardware, software, or a combination of both. The head module 300 may be an embodiment of the head module 120 in FIG. 1. In the embodiments of FIG. 3, the head module 300 includes a partition module 310, an integration module 320, an aggregation module 330, and an output module 340. In other embodiments, alternative configurations, different or additional components may be included in the DNN 100. Further, functionality attributed to a component of the DNN 100 may be accomplished by a different component included in the DNN 100 or a different system.

The partition module 310 partitions the feature map into feature groups. The feature map maybe generated by a backbone network of the DNN. Examples of the feature map include the OFM 140 in FIG. 1 and the OFM 260 in FIG. 2. In some embodiments, the partition module 310 partitions the feature map along the channel dimension. In an example where the number of channels in the feature map is C, the partition module 310 can partition the feature map into N feature groups. The number of channels in each of the feature groups is N/C. Nis an integer, such as 2, 4, 8, 16, and so on. In some embodiments, the partition module 310 determines the value of N based on the value of C. For instance, for a larger C, the partition module 310 may determine a larger N. The channel height and channel weight in each feature group can be the same as the channel height and channel weight, respectively, of the feature map. The feature groups can be further processed in parallel by the integration module 320.

The integration module 320 receives feature groups from the partition module 310 and generates local tensors from the feature maps. The integration module 320 can process the feature groups separately. In some embodiments, the integration module 320 may process the feature groups in parallel. The integration module 320 includes a splitting module 350, an embedding module 360, and a mixing module 370.

The splitting module 350 splits each feature group into two separate feature subgroups. The splitting module 350 may partition the feature group along the channel dimension based on a split ratio. The split ratio indicates the number of channels in each of the two feature subgroups. In an example where the number of channels in a feature group is C/N and the split ratio is r, the number of channels in the two feature subgroups can be r C/N and (1−r)C/N, respectively. r may be a fraction, such as ½, ¼, ⅛, and so on. In some embodiments, the splitting module 350 determines the value of r based on the value of C/N. For instance, for a larger C/N, the partition module 310 may determine a smaller r. The channel height and channel weight in each feature subgroup can be the same as the channel height and channel weight, respectively, of the feature group and the feature map.

The embedding module 360 converts a pair of feature subgroups generated from a single feature group into an attention tensor and a value tensor. In some embodiments, the embedding module 360 generates the attention tensor and value tensor through convolutional operations. In some embodiments, the embedding module 360 converts the first feature subgroup in the pair to an attention tensor through a convolutional operation and an activation function. The embedding module 360 may perform the convolutional operation on a convolutional kernel and the first feature subgroup to generate a new tensor. The embedding module 360 may then apply an activation function to the new tensor, which results in the attention tensor. In some embodiments, each pixel in the first feature subgroup is projected to an image category dimension M. The attention tensor can encode dense position-specific object category attentions.

The embedding module 360 may also convert the second feature subgroup in the chair to a value tensor, e.g., through a convolutional operation. The embedding module 360 may perform the convolutional operation on a convolutional kernel and the second feature subgroup to generate the value tensor. The convolutional kernel for generating the value tensor may be different from the convolutional kernel for generating the attention tensor. The value tensor may have same dimensions as the attention tensor, e.g., the channel height, channel width, and the number of channels in the two tensors may be the same. Parameters in the convolutional kernels and the activation function may be determined through training the DNN.

The mixing module 370 generates a local tensor from a pair of attention tensor and value tensor. In some embodiments, the mixing module 370 makes an interaction between the attention tensor and the value tensor via the Hadamard product to generate the local tensor. For instance, the mixing module 370 performs an elementwise multiplication operation on the attention tensor and the value tensor. The result of the elementwise multiplication operation may be the local tensor. The local tensor may have same dimensions as the attention tensor or value tensor, e.g., the channel height, channel width, and the number of channels may be the same. An individual local tensor may include MC/N learnable parameters.

The aggregation module 330 aggregates the local tensors from the integration module 320 and generates a global vector. All the local tensor generated from a feature map can have the same dimensions. In some embodiments, the aggregation module 330 performs a summation of the local tensors along the spatial dimension to generate the global vector.

The output module 340 receive the global vector and determine an output of the DNN based on the global vector. In some embodiments, the output module 340 is a classifier, such as a softmax classifier. The output may have one or more values, each of which indicates a likelihood of the input (or a portion of the input) falls into a category. In some embodiments, the sum of the one or more values in the output is 1. In other embodiments, the output may be a prediction, an estimation, or other types of determination by the DNN.

### Example Feature Partition

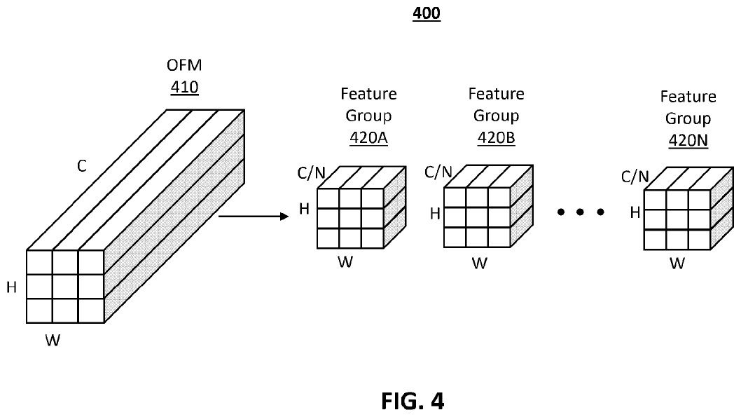

FIG. 4 illustrates a feature partition process 400, in accordance with various embodiments. The feature partition process 400 may be performed by the partition module 310 in FIG. 3. The feature partition process 400 starts with an OFM 410, which may be an output of a backbone network of a DNN. The OFM 410 may be an output of a convolutional layer, a pooling layer, or a different layer in the backbone network.

As shown in FIG. 4, the OFM 410 has a spatial size of H×W×C. His the dimension of the OFM 410 along the channel height axis. Wis the dimension of the OFM 410 along the channel width axis. Cis the dimension of the OFM 410 along the channel axis. The OFM 410 is split into N feature groups 420A-420N (collectively referred to as “feature groups 420” or “feature group 420”). Each feature group 420 may be a tensor having the same channel height and channel width but have a different number of channels from the OFM 410. In some embodiments, the partition can be performed along the channel axis, and the feature groups 420 have the same size. A feature group 420 can have a spatial size of H×W×C/N. In an embodiment where the OFM 410 is denoted as F, the feature groups 420 can be denoted as F₁, F₂, . . . , F_{N}∈R^{H×W×C/N}.

### Example Feature Integration Process

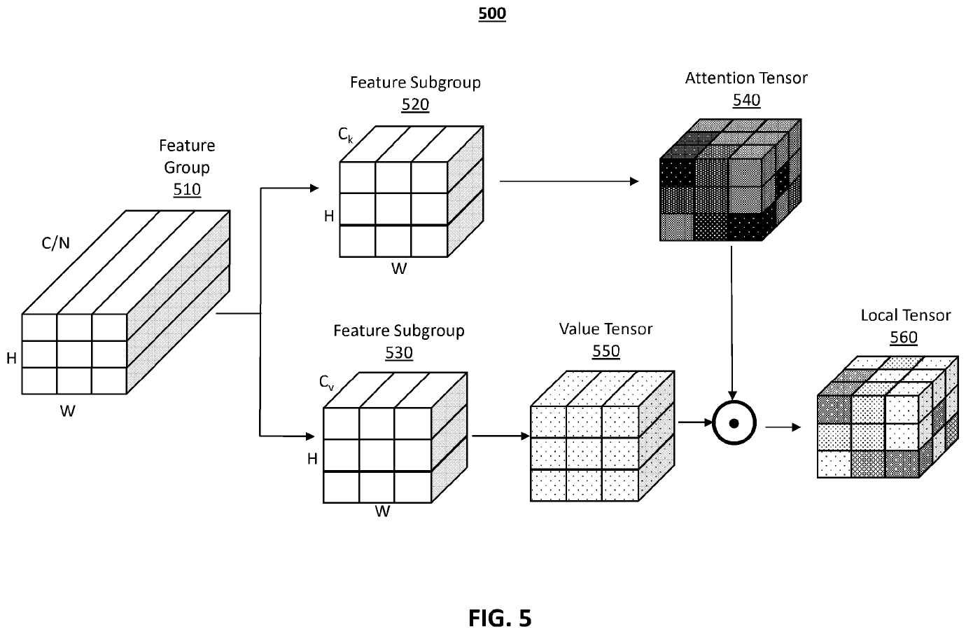

FIG. 5 illustrates a feature integration process 500, in accordance with various embodiments. The feature integration process 500 may be performed by the integration module 320 in FIG. 3. The feature integration process 500 starts with a feature group 510. The feature group 510 may be one of the feature groups 420 in FIG. 4.

As shown in FIG. 5, the feature group 510 is split to two feature subgroups 520 and 530. The splitting may be done by the splitting module 350. The feature subgroup 520 has a spatial size of H×W×Cₖ. The feature subgroup 530 has a spatial size of H×W×C_{y}. In some embodiments, the feature subgroups 520 and 530 may have different sizes. The number of channels in the feature subgroups 520 and 530 may be different, i.e., Cₖ is different from C_{y}. In some embodiments, Cₖ=rC/N and C_{y}=(1−r)C/N, where r is a splitting factor. In an example where the feature group 510 is an i^{th} feature group in the feature groups 420, the feature group 510 may be denoted as Fᵢ∈R^{H×w×C/N}; 1≤i≤N. The feature subgroups 520 and 530 may be denoted as Fₖᵢ∈R^{H×W×C}^{ₖ} and Fᵥᵢ∈R^{H×W×C}^{ᵥ}, respectively.

Then, the feature subgroup 520 is converted to an attention tensor 540. The may be done by the embedding module 360. In some embodiments, a convolutional operation is conducted on the feature subgroup 520 based on a convolutional kernel Wₖᵢ∈R^{1×1×C}^{ₖ}^{×M}, e.g., along the channel dimension. M may denote the number of image classes. An activation function may further be applied to the result of the convolutional operation, e.g., across the spatial dimension. Each pixel in the feature subgroup 520 Fₖᵢ is projected to a desired image category dimension M, producing the attention tensor 540, which can be denoted as Aᵢ∈R^{H×W×M}. The conversion may be denoted as:

$${A}_{i} = softmax ( {W}_{ki} * {F}_{ki} )$$

The feature subgroup 530 is converted to a value tensor 550. The conversion may be done by the embedding module 360. In some embodiments, a convolutional operation is conducted on the feature subgroup 530 based on a convolutional kernel Wᵥᵢ∈R^{1×1×C}^{ᵥ}^{×M}. The result of the conversion is the value tensor 550, which can be denoted as Vᵢ∈R^{H×W×M}. The value tensor 550 has the same dimension as the attention tensor 540. The conversion may be defined as:

$${V}_{i} = {W}_{vi} * {F}_{vi}$$

The attention tensor 540 and the value tensor 550 are mixed to generate a local tensor 560. The local tensor 560 may be a local POCA (pairwise object category attention) tensor. The local tensor 560 may be a result of an elementwise multiplication of the attention tensor 540 and the value tensor 550. The mixing process (with the Hadamard product, denoted as ⊙) may be defined as:

$${P}_{i} = {A}_{i} ⊙ {V}_{i}$$

where Pᵢ is the local tensor 560. The feature integration process 500 can product local tensors for all the feature groups generated from an OFM. In the embodiments where there are N feature groups, the feature integration process 500 can product N local tensors P₁, P₂, . . . P_{N}∈R^{H×W×M}.

### Example Feature Aggregation Process

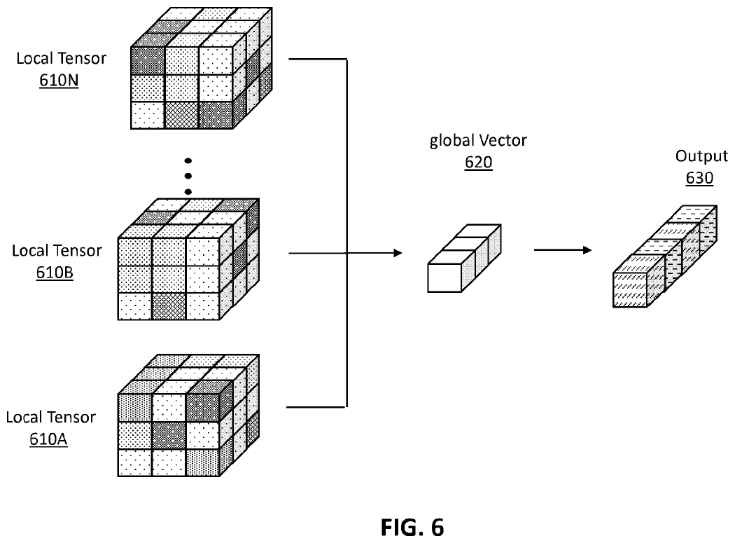

FIG. 6 illustrates a feature aggregation process 600, in accordance with various embodiments. The feature aggregation process 600 may be performed by the aggregation module 330 in FIG. 3. The feature aggregation process 600 starts with N local tensors 610A-610N (collectively referred to as “local tensors 610” or “local tensor 610”). A local tensor 610 may be the local tensor 560 in FIG. 5. The local tensors 560 may be generated from the same OFM, such as the OFM 410 in FIG. 4.

In the feature aggregation process 600, all the local tensors 610 are summed to produce a global vector 620. The global vector 620 may have the number of channels as a local tensor 610. In an embodiment where a local tensor is P∈R^{H×W×M}, the global vector 620 may be denoted as P∈R^{1×1×M}. The global vector 620 may be a result of summations of the local tensors 610 along the spatial dimension. The feature aggregation process 600 may include HWMN adds. The value in each channel in the global vector 620 may be the sum of all the NHW pixels in the same channel in the local tensors 610. NHW represents the product of N, H, and W.

After the global vector 620 is generated, it is processed to generate an output 630, e.g., by using a classifier. The classifier may perform aggregation or multiplication operations on the global vector 620, the result of which may be one or more values in the output 630. In some embodiments, the classifier performs M adds.

Compared with conventional methods for head computation, the head module 300 can provide a more efficient solution. For instance, the head module 300 may MC parameters and require HWMC+2HWMN+M MAC operations, which provides more simplicity in the computation in the DNN. Such a solution would require less power, computation resource, and time. Moreover, the architecture of the head module 300 makes it compatible with various types of backbone networks, including CNN, ViT, and MLP. The head module 300 can be use as a global head for DNNs. The spatial sizes of the feature groups, feature subgroups, tensors, global vector, and output shown in FIGS. 4-6 are examples used for purpose of illustration. In other embodiments, a feature group, feature subgroup, attention tensor, value tenor, local tensor, global vector, or output may have different spatial sizes.

### Example Method of Training Neural Network

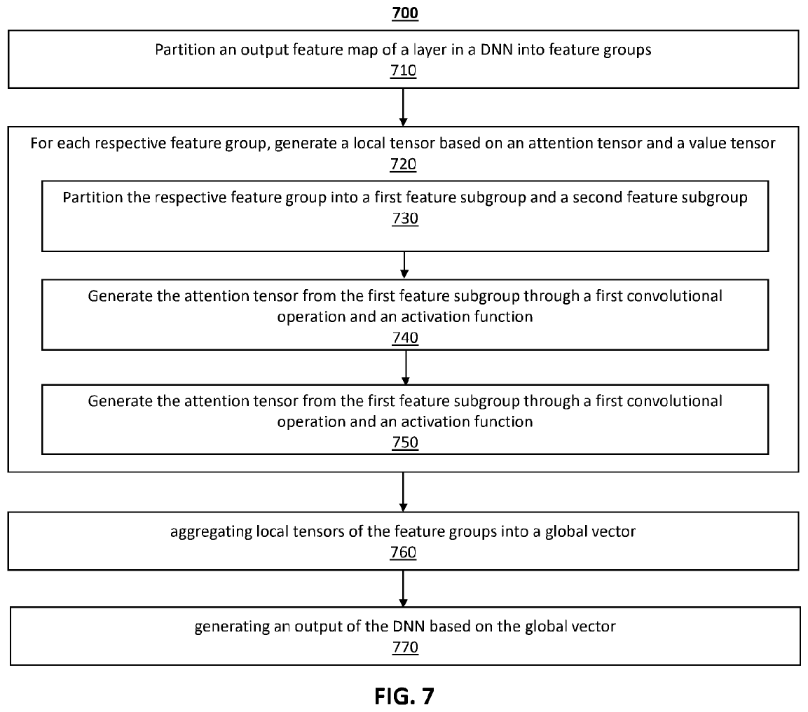

FIG. 7 is a flowchart showing a method 700 of DL, in accordance with various embodiments. The method 700 may be performed by the head module 300 in FIG. 3. Although the method 700 is described with reference to the flowchart illustrated in FIG. 7, many other methods for DL may alternatively be used. For example, the order of execution of the steps in FIG. 7 may be changed. As another example, some of the steps may be changed, eliminated, or combined.

The head module 300 partitions 710 an OFM of a layer in a DNN into feature groups. In some embodiments, the DNN comprises a sequence of convolutional layers. The layer may be a last convolutional layer in the sequence. The OFM may also be referred to as an output tensor. The OFM includes a plurality of channels. A channel of the plurality of channels is a matrix comprising a plurality of values. Each value may be referred to as a pixel or element. The number of values in a column of the matrix may be referred to as a channel height of the OFM. The number of values in a row of the matrix may be referred to as a channel width of the OFM. The feature groups are different portions of the OFM. In some embodiments, the feature groups include different portions of the plurality of channels in the OFM. The feature groups have a same number of channels. The channel height or channel width of a feature group may be the same as the channel height or channel width of the OFM.

For each respective feature group, the head module 300 generates 720 a local tensor based on an attention tensor and a value tensor. In some embodiments, the head module 300 generate the local tensor by applying an elementwise multiplication operation on the attention tensor and the value tensor.

The head module 300 partitions 730 the respective feature group into a first feature subgroup and a second feature subgroup. The head module 300 generates 740 the attention tensor from the first feature subgroup through a first convolutional operation and an activation function. In some embodiments, the head module 300 performs the first convolutional operation on the first feature subgroup and a first convolutional kernel to generate a tensor. The head module 300 then applies the activation function on the tensor to generate the attention tensor.

The head module 300 generates 750 the value tensor from the second feature subgroup through a second convolutional operation. In some embodiments, the head module 300 performs the second convolutional operation on the second feature subgroup and a second convolutional kernel to generate the value tensor. The second convolutional kernel is different from the first convolutional kernel. A number of channels in the first feature subgroup may be different from a number of channels in the second feature subgroup, but the attention tensor and the value tensor have a same number of channels.

The head module 300 aggregates 760 local tensors of the feature groups into a global vector. For instance, the head module 300 may aggregate corresponding values in each of the local tensors to generate a value in the global vector. The values in the local tensors and the value of the global vector may have the same position. The value of the global vector may be the sum of the values in the local tensors. The global vector may have the same spatial size as the local tensors, e.g., same channel height, channel width, or number of channels.

The head module 300 generates 770 an output of the DNN based on the global vector. In some embodiments, the head module 300 inputs the global vector into a classifier, such as a softmax classifier. The classifier generates the output, and the output comprises one or more values indicating one or more classifications.

### Example DL Environment

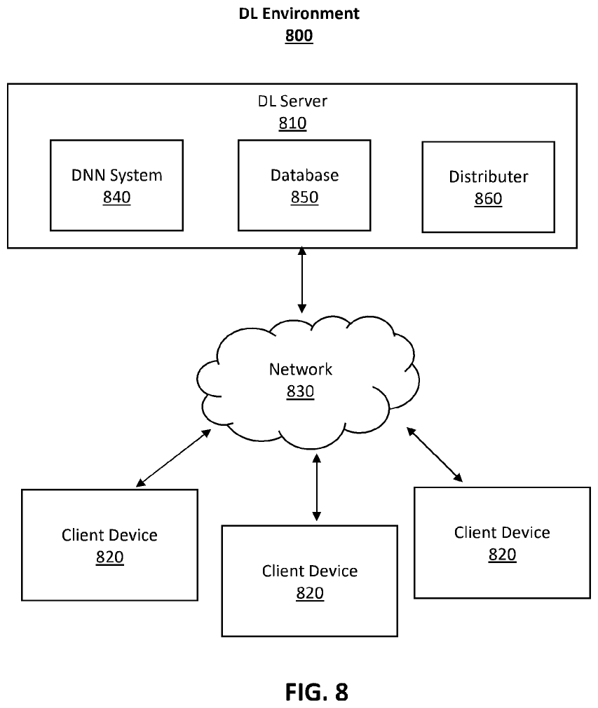

FIG. 8 illustrates a DL environment 800, in accordance with various embodiments. The DL environment 800 includes a DL server 810 and a plurality of client devices 820 (individually referred to as client device 820). The DL server 810 is connected to the client devices 820 through a network 830. In other embodiments, the DL environment 800 may include fewer, more, or different components.

The DL server 810 trains DL models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The DL server 810 can use various types of neural networks, such as DNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The DL server 810 may build DL models specific to particular types of problems that need to be solved. A DL model is trained to receive an input and outputs the solution to the particular problem.

In FIG. 8, the DL server 810 includes a DNN system 840, a database 850, and a distributer 860. The DNN system 840 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 in FIG. 1 or the DNN in FIG. 2. In some embodiments, the DNN system 840 trains DNNs through knowledge distillation, e.g., dense-connection based knowledge distillation. The trained DNNs may be used on low memory systems, like mobile phones, IOT edge devices, and so on.

The database 850 stores data received, used, generated, or otherwise associated with the DL server 810. For example, the database 850 stores a training dataset that the DNN system 840 uses to train DNNs. In an embodiment, the training dataset is an image gallery that can be used to train a DNN for classifying images. The training dataset may include data received from the client devices 820. As another example, the database 850 stores hyperparameters of the neural networks built by the DL server 810.

The distributer 860 distributes DL models generated by the DL server 810 to the client devices 820. In some embodiments, the distributer 860 receives a request for a DNN from a client device 820 through the network 830. The request may include a description of a problem that the client device 820 needs to solve. The request may also include information of the client device 820, such as information describing available computing resource on the client device. The information describing available computing resource on the client device 820 can be information indicating network bandwidth, information indicating available memory size, information indicating processing power of the client device 820, and so on. In an embodiment, the distributer may instruct the DNN system 840 to generate a DNN in accordance with the request. The DNN system 840 may generate a DNN based on the information in the request. For instance, the DNN system 840 can determine the structure of the DNN and/or train the DNN in accordance with the request.

In another embodiment, the distributer 860 may select the DNN from a group of pre-existing DNNs based on the request. The distributer 860 may select a DNN for a particular client device 830 based on the size of the DNN and available resources of the client device 830. In embodiments where the distributer 860 determines that the client device 830 has limited memory or processing power, the distributer 860 may select a compressed DNN for the client device 830, as opposed to an uncompressed DNN that has a larger size. The distributer 860 then transmits the DNN generated or selected for the client device 820 to the client device 820.

In some embodiments, the distributer 860 may receive feedback from the client device 820. For example, the distributer 860 receives new training data from the client device 820 and may send the new training data to the DNN system 840 for further training the DNN. As another example, the feedback includes an update of the available computer resource on the client device 820. The distributer 860 may send a different DNN to the client device 820 based on the update. For instance, after receiving the feedback indicating that the computing resources of the client device 820 have been reduced, the distributer 860 sends a DNN of a smaller size to the client device 820.

The client devices 820 receive DNNs from the distributer 860 and applies the DNNs to perform machine learning tasks, e.g., to solve problems or answer questions. In various embodiments, the client devices 820 input images into the DNNs and uses the output of the DNNs for various applications, e.g., visual reconstruction, augmented reality, robot localization and navigation, medical diagnosis, weather prediction, and so on. A client device 820 may be one or more computing devices capable of receiving user input as well as transmitting and/or receiving data via the network 830. In one embodiment, a client device 820 is a conventional computer system, such as a desktop or a laptop computer. Alternatively, a client device 820 may be a device having computer functionality, such as a personal digital assistant (PDA), a mobile telephone, a smartphone, an autonomous vehicle, or another suitable device. A client device 820 is configured to communicate via the network 830. In one embodiment, a client device 820 executes an application allowing a user of the client device 820 to interact with the DL server 810 (e.g., the distributer 860 of the DL server 810). The client device 820 may request DNNs or send feedback to the distributer 860 through the application. For example, a client device 820 executes a browser application to enable interaction between the client device 820 and the DL server 810 via the network 830. In another embodiment, a client device 820 interacts with the DL server 810 through an application programming interface (API) running on a native operating system of the client device 820, such as IOS® or ANDROID™.

In an embodiment, a client device 820 is an integrated computing device that operates as a standalone network-enabled device. For example, the client device 820 includes display, speakers, microphone, camera, and input device. In another embodiment, a client device 820 is a computing device for coupling to an external media device such as a television or other external display and/or audio output system. In this embodiment, the client device 820 may couple to the external media device via a wireless interface or wired interface (e.g., an HDMI cable) and may utilize various functions of the external media device such as its display, speakers, microphone, camera, and input devices. Here, the client device 820 may be configured to be compatible with a generic external media device that does not have specialized software, firmware, or hardware specifically for interacting with the client device 820.

The network 830 supports communications between the DL server 810 and client devices 820. The network 830 may comprise any combination of local area and/or wide area networks, using both wired and/or wireless communication systems. In one embodiment, the network 830 may use standard communications technologies and/or protocols. For example, the network 830 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 830 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 830 may be represented using any suitable format, such as hypertext markup language (HTML) or extensible markup language (XML). In some embodiments, all or some of the communication links of the network 830 may be encrypted using any suitable technique or techniques.

### Example DNN System

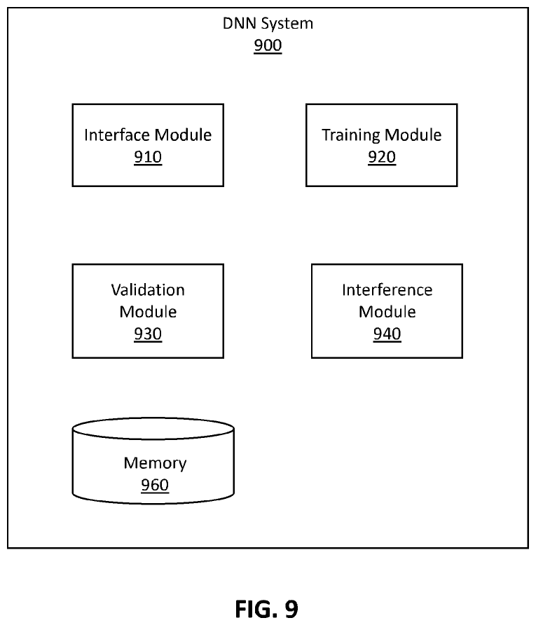

FIG. 9 is a block diagram of an example DNN system 900, in accordance with various embodiments. The DNN system 900 trains DNNs for various tasks, such as image classification, learning relationships between biological cells (e.g., DNA, proteins, etc.), control behaviors for devices (e.g., robots, machines, etc.), and so on. The DNN system 900 includes an interface module 910, a training module 920, a validation module 930, an inference module 940, and a memory 950. In other embodiments, alternative configurations, different or additional components may be included in the DNN system 900. Further, functionality attributed to a component of the DNN system 900 may be accomplished by a different component included in the DNN system 900 or a different system.

The interface module 910 facilitates communications of the DNN system 900 with other systems. For example, the interface module 910 establishes communications between the DNN system 900 with an external database to receive data that can be used to train DNNs or input into DNNs to perform tasks. As another example, the interface module 910 supports the DNN system 900 to distribute DNNs to other systems, e.g., computing devices configured to apply DNNs to perform tasks.

The training module 920 trains DNNs by using a training dataset. The training module 920 forms the training dataset. In an embodiment where the training module 920 trains an DNN to recognize objects in images, the training dataset includes training images and training labels. The training labels describe ground truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 930 to validate performance of a trained DNN. The portion of the training dataset not including the tuning subset and the validation subset may be used to train the DNN.

The training module 920 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the DL algorithm works through the entire training dataset. One epoch means that each training sample in the training dataset has had an opportunity to update the parameters inside the DNN. An epoch may include one or more batches. The number of epochs may be 9, 90, 500, 900, or even larger.

The training module 920 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the DNN, the training module 920 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 920 defines the architecture of the DNN, the training module 920 inputs a training dataset into the DNN. The training dataset includes a plurality of training samples. An example of a training sample includes an object in an image and a ground truth label of the object. The training module 920 modifies the parameters inside the DNN (“internal parameters of the DNN”) to minimize the error between labels of the training objects that are generated by the DNN and the ground truth labels of the objects. The internal parameters include weights of filters in the convolutional layers of the DNN. In some embodiments, the training module 920 uses a cost function to minimize the error.

The training module 920 may train the DNN for a predetermined number of epochs. The number of epochs is a hyperparameter that defines the number of times that the DL algorithm will work through the entire training dataset. One epoch means that each sample in the training dataset has had an opportunity to update internal parameters of the DNN. After the training module 920 finishes the predetermined number of epochs, the training module 920 may stop updating the parameters in the DNN. The DNN having the updated parameters is referred to as a trained DNN.

The validation module 930 verifies accuracy of trained DNNs. In some embodiments, the validation module 930 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 930 determines may determine an accuracy score measuring the precision, recall, or a combination of precision and recall of the DNN. The validation module 930 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 930 may compare the accuracy score with a threshold score. In an example where the validation module 930 determines that the accuracy score of the augmented model is lower than the threshold score, the validation module 930 instructs the training module 920 to re-train the DNN. In one embodiment, the training module 920 may iteratively re-train the DNN until the occurrence of a stopping condition, such as the accuracy measurement indication that the DNN may be sufficiently accurate, or a number of training rounds having taken place.

The inference module 940 applies the trained or validated DNN to perform tasks. For instance, the inference module 940 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like. In some embodiments, the inference module 940 distributes the DNN to other systems, e.g., computing devices in communication with the DNN system 900, for the other systems to apply the DNN to perform the tasks.

The memory 950 stores data received, generated, used, or otherwise associated with the DNN system 900. For example, the memory 950 stores the datasets used by the training module 920 and validation module 930. The memory 950 may also store data generated by the training module 920 and validation module 930, such as the hyperparameters for training DNNs, internal parameters of trained DNNs (e.g., values of tunable parameters of FALUs), etc. In the embodiment of FIG. 9, the memory 950 is a component of the DNN system 900. In other embodiments, the memory 950 may be external to the DNN system 900 and communicate with the DNN system 900 through a network.

### Example Computing Device

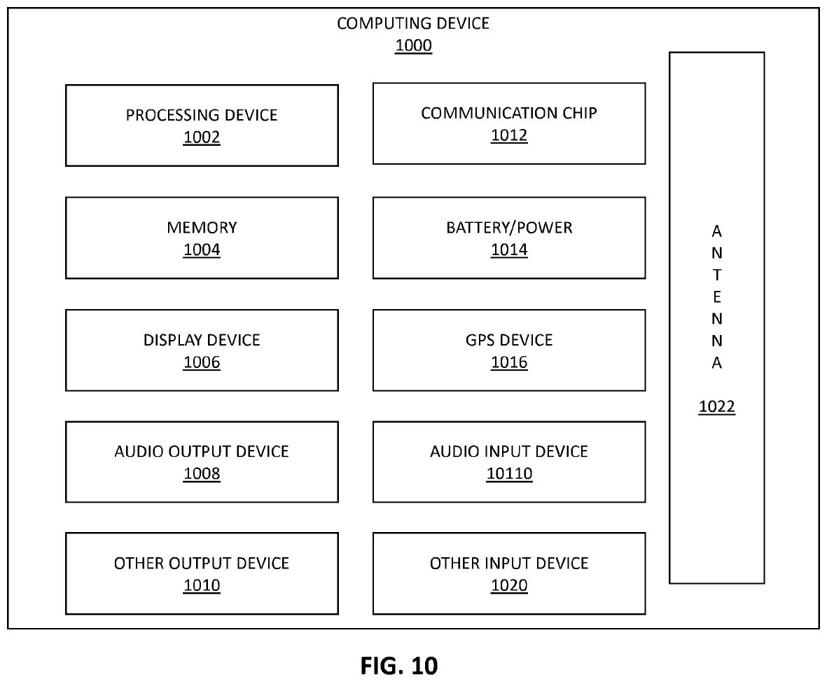

FIG. 10 is a block diagram of an example computing device 1000, in accordance with various embodiments. A number of components are illustrated in FIG. 10 as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, but the computing device 1000 may include interface circuitry for coupling to the one or more components. For example, the computing device 1000 may not include a display device 1006, but may include display device interface circuitry (e.g., a connector and driver circuitry) to which a display device 1006 may be coupled. In another set of examples, the computing device 1000 may not include an audio input device 1018 or an audio output device 1008, but may include audio input or output device interface circuitry (e.g., connectors and supporting circuitry) to which an audio input device 1018 or audio output device 1008 may be coupled.

The computing device 1000 may include a processing device 1002 (e.g., one or more processing devices). The processing device 1002 processes electronic data from registers and/or memory to transform that electronic data into other electronic data that may be stored in registers and/or memory. The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1004 may include memory that shares a die with the processing device 1002. In some embodiments, the memory 1004 includes one or more non-transitory computer-readable media storing instructions executable to perform operations for DL, e.g., the method 700 described above in conjunction with FIG. 7 or the operations performed by the head module 300 described above in conjunction with FIG. 3. The instructions stored in the one or more non-transitory computer-readable media may be executed by the processing device 1002.

In some embodiments, the computing device 1000 may include a communication chip 1012 (e.g., one or more communication chips). For example, the communication chip 1012 may be configured for managing wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1012 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1012 may operate in accordance with other wireless protocols in other embodiments. The computing device 1000 may include an antenna 1022 to facilitate wireless communications and/or to receive other wireless communications (such as AM or FM radio transmissions).

In some embodiments, the communication chip 1012 may manage wired communications, such as electrical, optical, or any other suitable communication protocols (e.g., the Ethernet). As noted above, the communication chip 1012 may include multiple communication chips. For instance, a first communication chip 1012 may be dedicated to shorter-range wireless communications such as Wi-Fi or Bluetooth, and a second communication chip 1012 may be dedicated to longer-range wireless communications such as global positioning system (GPS), EDGE, GPRS, CDMA, WiMAX, LTE, EV-DO, or others. In some embodiments, a first communication chip 1012 may be dedicated to wireless communications, and a second communication chip 1012 may be dedicated to wired communications.

The computing device 1000 may include battery/power circuitry 1014. The battery/power circuitry 1014 may include one or more energy storage devices (e.g., batteries or capacitors) and/or circuitry for coupling components of the computing device 1000 to an energy source separate from the computing device 1000 (e.g., AC line power).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include an other output device 1010 (or corresponding interface circuitry, as discussed above). Examples of the other output device 1010 may include an audio codec, a video codec, a printer, a wired or wireless transmitter for providing information to other devices, or an additional storage device.

The computing device 1000 may include an other input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (register fileID) reader.

The computing device 1000 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1000 may be any other electronic device that processes data.

### SELECT EXAMPLES

The following paragraphs provide various examples of the embodiments disclosed herein.

Example 1 provides a method for DL, the method including partitioning an OFM of a layer in a DNN into feature groups, where the OFM includes a plurality of channels, a channel of the plurality of channels is a matrix including a plurality of values, and the feature groups are different portions of the OFM; for each respective feature group: partitioning the respective feature group into a first feature subgroup and a second feature subgroup, generating an attention tensor from the first feature subgroup through a first convolutional operation and an activation function, generating a value tensor from the second feature subgroup through a second convolutional operation, and generating a local tensor based on the attention tensor and the value tensor; aggregating local tensors of the feature groups into a global vector; and generating an output of the DNN based on the global vector.

Example 2 provides the method of example 1, where the feature groups include different portions of the plurality of channels in the OFM.

Example 3 provides the method of example 1 or 2, where the feature groups have a same number of channels.

Example 4 provides the method of any of the preceding examples, where generating the attention tensor from the first feature subgroup through the first convolutional operation and the activation function includes performing the first convolutional operation on the first feature subgroup and a first convolutional kernel to generate a tensor; and applying the activation function on the tensor to generate the attention tensor.

Example 5 provides the method of example 4, where generating the value tensor from the second feature subgroup through the second convolutional operation includes performing the second convolutional operation on the second feature subgroup and a second convolutional kernel to generate the value tensor, where the second convolutional kernel is different from the first convolutional kernel.

Example 6 provides the method of any of the preceding examples, where a number of channels in the first feature subgroup is different from a number of channels in the second feature subgroup.

Example 7 provides the method of example 6, where the attention tensor and the value tensor have a same number of channels.

Example 8 provides the method of any of the preceding examples, where generating the local tensor based on the attention tensor and the value tensor includes applying an elementwise multiplication operation on the attention tensor and the value tensor.

Example 9 provides the method of any of the preceding examples, where generating the output of the DNN based on the global vector includes inputting the global vector into a classifier, where the classifier generates the output, and the output includes one or more values indicating one or more classifications.

Example 10 provides the method of any of the preceding examples, where the DNN includes a sequence of convolutional layers, and the layer is a last convolutional layer in the sequence.

Example 11 provides one or more non-transitory computer-readable media storing instructions executable to perform operations for training a target neural network, the operations including partitioning an OFM of a layer in a DNN into feature groups, where the OFM includes a plurality of channels, a channel of the plurality of channels is a matrix including a plurality of values, and the feature groups are different portions of the OFM; for each respective feature group partitioning the respective feature group into a first feature subgroup and a second feature subgroup, generating an attention tensor from the first feature subgroup through a first convolutional operation and an activation function, generating a value tensor from the second feature subgroup through a second convolutional operation, and generating a local tensor based on the attention tensor and the value tensor; aggregating local tensors of the feature groups into a global vector; and generating an output of the DNN based on the global vector.

Example 12 provides the one or more non-transitory computer-readable media of example 11, where the feature groups include different portions of the plurality of channels in the OFM.

Example 13 provides the one or more non-transitory computer-readable media of example 12, where the feature groups have a same number of channels.

Example 14 provides the one or more non-transitory computer-readable media of any of examples 11-13, where generating the attention tensor from the first feature subgroup through the first convolutional operation and the activation function includes performing the first convolutional operation on the first feature subgroup and a first convolutional kernel to generate a tensor; and applying the activation function on the tensor to generate the attention tensor.

Example 15 provides the one or more non-transitory computer-readable media of example 14, where generating the value tensor from the second feature subgroup through the second convolutional operation includes performing the second convolutional operation on the second feature subgroup and a second convolutional kernel to generate the value tensor,

where the second convolutional kernel is different from the first convolutional kernel.

Example 16 provides the one or more non-transitory computer-readable media of any of examples 11-15, where a number of channels in the first feature subgroup is different from a number of channels in the second feature subgroup.

Example 17 provides the one or more non-transitory computer-readable media of example 16, where the attention tensor and the value tensor have a same number of channels.

Example 18 provides the one or more non-transitory computer-readable media of any of examples 11-17, where generating the local tensor based on the attention tensor and the value tensor includes: applying an elementwise multiplication operation on the attention tensor and the value tensor.

Example 19 provides the one or more non-transitory computer-readable media of any of examples 11-18, where generating the output of the DNN based on the global vector includes inputting the global vector into a classifier, where the classifier generates the output, and the output includes one or more values indicating one or more classifications.

Example 20 provides the one or more non-transitory computer-readable media of any of examples 11-19, where the DNN includes a sequence of convolutional layers, and the layer is a last convolutional layer in the sequence.

Example 21 provides a DNN, the DNN including a backbone network configured to receive an input, and extract features from the input to generate an OFM, where the OFM includes a plurality of channels, a channel of the plurality of channels is a matrix including a plurality of values; and a head module configured to partition the OFM into feature groups, where the feature groups are different portions of the OFM, for each respective feature group, generate a local tensor by partition the respective feature group into a first feature subgroup and a second feature subgroup, generate an attention tensor from the first feature subgroup through a first convolutional operation and an activation function, generate a value tensor from the second feature subgroup through a second convolutional operation, and generate a local tensor based on the attention tensor and the value tensor, aggregate local tensors of the feature groups into a global vector, and generate an output of the DNN based on the global vector.

Example 22 provides the DNN of example 21, where the feature groups include different portions of the plurality of channels in the OFM.

Example 23 provides the DNN of example 21 or 22, where the feature groups have a same number of channels.

Example 24 provides the DNN of any of examples 21-23, where a number of channels in the first feature subgroup is different from a number of channels in the second feature subgroup, and the attention tensor and the value tensor have a same number of channels.

Example 25 provides the DNN of any of examples 21-24, where the head module is configured to generate the local tensor based on the attention tensor and the value tensor by applying an elementwise multiplication operation on the attention tensor and the value tensor.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1-25. (canceled)

26. A method for deep learning, the method comprising:
partitioning an output feature map of a layer in a deep neural network (DNN) into feature groups, wherein the output feature map comprises a plurality of channels, a channel of the plurality of channels is a matrix comprising a plurality of values, and the feature groups are different portions of the output feature map;
for each respective feature group:
partitioning the respective feature group into a first feature subgroup and a second feature subgroup,
generating an attention tensor from the first feature subgroup through a first convolutional operation and an activation function,
generating a value tensor from the second feature subgroup through a second convolutional operation, and
generating a local tensor based on the attention tensor and the value tensor;
aggregating local tensors of the feature groups into a global vector; and
generating an output of the DNN based on the global vector.

27. The method of claim 26, wherein the feature groups include different portions of the plurality of channels in the output feature map.

28. The method of claim 26, wherein the feature groups have a same number of channels.

29. The method of claim 26, wherein generating the attention tensor from the first feature subgroup through the first convolutional operation and the activation function comprises:
performing the first convolutional operation on the first feature subgroup and a first convolutional kernel to generate a tensor; and
applying the activation function on the tensor to generate the attention tensor.

30. The method of claim 29, wherein generating the value tensor from the second feature subgroup through the second convolutional operation comprises:
performing the second convolutional operation on the second feature subgroup and a second convolutional kernel to generate the value tensor,
wherein the second convolutional kernel is different from the first convolutional kernel.

31. The method of claim 26, wherein a number of channels in the first feature subgroup is different from a number of channels in the second feature subgroup.

32. The method of claim 6, wherein the attention tensor and the value tensor have a same number of channels.

33. The method of claim 26, wherein generating the local tensor based on the attention tensor and the value tensor comprises:
applying an elementwise multiplication operation on the attention tensor and the value tensor.

34. The method of claim 26, wherein generating the output of the DNN based on the global vector comprises:
inputting the global vector into a classifier,
wherein the classifier generates the output, and the output comprises one or more values indicating one or more classifications.

35. The method of claim 26, wherein the DNN comprises a sequence of convolutional layers, and the layer is a last convolutional layer in the sequence.

36. One or more non-transitory computer-readable media storing instructions executable to perform operations for training a target neural network, the operations comprising:
partitioning an output feature map of a layer in a deep neural network (DNN) into feature groups, wherein the output feature map comprises a plurality of channels, a channel of the plurality of channels is a matrix comprising a plurality of values, and the feature groups are different portions of the output feature map;
for each respective feature group:
partitioning the respective feature group into a first feature subgroup and a second feature subgroup,
generating an attention tensor from the first feature subgroup through a first convolutional operation and an activation function,
generating a value tensor from the second feature subgroup through a second convolutional operation, and
generating a local tensor based on the attention tensor and the value tensor;
aggregating local tensors of the feature groups into a global vector; and
generating an output of the DNN based on the global vector.

37. The one or more non-transitory computer-readable media of claim 36, wherein the feature groups include different portions of the plurality of channels in the output feature map.

38. The one or more non-transitory computer-readable media of claim 36, wherein generating the attention tensor from the first feature subgroup through the first convolutional operation and the activation function comprises:
performing the first convolutional operation on the first feature subgroup and a first convolutional kernel to generate a tensor; and
applying the activation function on the tensor to generate the attention tensor.

39. The one or more non-transitory computer-readable media of claim 36, wherein a number of channels in the first feature subgroup is different from a number of channels in the second feature subgroup.

40. The one or more non-transitory computer-readable media of claim 36, wherein generating the local tensor based on the attention tensor and the value tensor comprises:
applying an elementwise multiplication operation on the attention tensor and the value tensor.

41. The one or more non-transitory computer-readable media of claim 36, wherein generating the output of the DNN based on the global vector comprises:
inputting the global vector into a classifier,
wherein the classifier generates the output, and the output comprises one or more values indicating one or more classifications.

42. The one or more non-transitory computer-readable media of claim 36, wherein the DNN comprises a sequence of convolutional layers, and the layer is a last convolutional layer in the sequence.

43. A deep neural network (DNN), the DNN comprising:
a backbone network configured to:
receive an input, and
extract features from the input to generate an output feature map, wherein the output feature map comprises a plurality of channels, a channel of the plurality of channels is a matrix comprising a plurality of values; and
a head module configured to:
partition the output feature map into feature groups, wherein the feature groups are different portions of the output feature map,
for each respective feature group, generate a local tensor by:
partition the respective feature group into a first feature subgroup and a second feature subgroup,
generate an attention tensor from the first feature subgroup through a first convolutional operation and an activation function,
generate a value tensor from the second feature subgroup through a second convolutional operation, and
generate a local tensor based on the attention tensor and the value tensor,
aggregate local tensors of the feature groups into a global vector, and
generate an output of the DNN based on the global vector.

44. The DNN of claim 43, wherein the feature groups include different portions of the plurality of channels in the output feature map.

45. The DNN of claim 43, wherein a number of channels in the first feature subgroup is different from a number of channels in the second feature subgroup, and the attention tensor and the value tensor have a same number of channels.
